(19) United States
(12) Patent Application Publication
(10) Pub. No.: US 2026/0131576 A1
(43) Pub. Date: May 14, 2026

(54) THERMAL PRINT HEAD

(71) Applicant: ROHM CO., LTD., Kyoto-shi (JP)

(72) Inventor: Goro NAKATANI, Kyoto-shi (JP)

(21) Appl. No.: 19/442,439

(22) Filed: Jan. 7, 2026

Related U.S. Application Data
(63) Continuation of application No. PCT/JP2024/020147, filed on Jun. 3, 2024.

(30) Foreign Application Priority Data
Jul. 14, 2023 (JP) 2023-115786

(51) Int. Cl. B41J 2/335; B41J 2/345

(52) U.S. Cl. CPC B41J 2/33515; B41J 2/3353; B41J 2/33535; B41J 2/3354; B41J 2/33545; B41J 2/3355; B41J 2/3358; B41J 2/3359; B41J 2/345

(57) ABSTRACT

A thermal print head includes a substrate and a glaze layer. The substrate has a main surface. The glaze layer is disposed on the main surface. The glaze layer includes a hollow filler.

### TECHNICAL FIELD

The present disclosure relates to a thermal print head.

### BACKGROUND ART

Japanese Patent Laying-Open No. 2022-180152 (PTL 1) discloses a thermal print head including a substrate, a resistor layer, and a conductor layer. The thermal print head has a heat generation portion.

### CITATION LIST

### Patent Literature

PTL 1: Japanese Patent Laying-Open No. 2022-180152

### BRIEF DESCRIPTION OF DRAWINGS

FIG. 1 is a schematic cross-sectional view of a thermal print head according to a first embodiment.

FIG. 2 is a schematic plan view of the thermal print head according to the first embodiment.

FIG. 3 is a partially enlarged schematic plan view of the thermal print head according to the first embodiment.

FIG. 4 is a partially enlarged schematic cross-sectional view of the thermal print head according to the first embodiment.

FIG. 5 is a schematic cross-sectional view of a glaze layer including hollow fillers.

FIG. 6 is a partially enlarged schematic cross-sectional view showing a step in a method of manufacturing the thermal print head according to the first embodiment.

FIG. 7 is a partially enlarged schematic cross-sectional view showing a step subsequent to the step shown in FIG. 6 in the method of manufacturing the thermal print head according to the first embodiment.

FIG. 8 is a partially enlarged schematic cross-sectional view showing a step subsequent to the step shown in FIG. 7 in the method of manufacturing the thermal print head according to the first embodiment.

FIG. 9 is a partially enlarged schematic cross-sectional view showing a step subsequent to the step shown in FIG. 8 in the method of manufacturing the thermal print head according to the first embodiment.

FIG. 10 is a partially enlarged schematic cross-sectional view showing a step subsequent to the step shown in FIG. 9 in the method of manufacturing the thermal print head according to the first embodiment.

FIG. 11 is a partially enlarged schematic cross-sectional view showing a step subsequent to the step shown in FIG. 10 in the method of manufacturing the thermal print head according to the first embodiment.

FIG. 12 is a partially enlarged schematic cross-sectional view showing a step subsequent to the step shown in FIG. 11 in the method of manufacturing the thermal print head according to the first embodiment.

FIG. 13 is a partially enlarged schematic cross-sectional view showing a step subsequent to the step shown in FIG. 12 in the method of manufacturing the thermal print head according to the first embodiment.

FIG. 14 is a partially enlarged schematic cross-sectional view showing a step subsequent to the step shown in FIG. 13 in the method of manufacturing the thermal print head according to the first embodiment.

FIG. 15 is a partially enlarged schematic cross-sectional view showing a step subsequent to the step shown in FIG. 14 in the method of manufacturing the thermal print head according to the first embodiment.

FIG. 16 is a partially enlarged schematic cross-sectional view of a thermal print head according to a second embodiment.

FIG. 17 is a partially enlarged schematic cross-sectional view showing a step subsequent to the step shown in FIG. 8 in a method of manufacturing the thermal print head according to the second embodiment.

FIG. 18 is a partially enlarged schematic cross-sectional view showing a step subsequent to the step shown in FIG. 17 in the method of manufacturing the thermal print head according to the second embodiment.

### DETAILED DESCRIPTION

Embodiments of the present disclosure will be described in detail with reference to the drawings. In the drawings, the same or corresponding portions are denoted by the same reference numerals, and the description thereof will not be repeated. At least some of configurations in the embodiments described below may be arbitrarily combined.

### First Embodiment

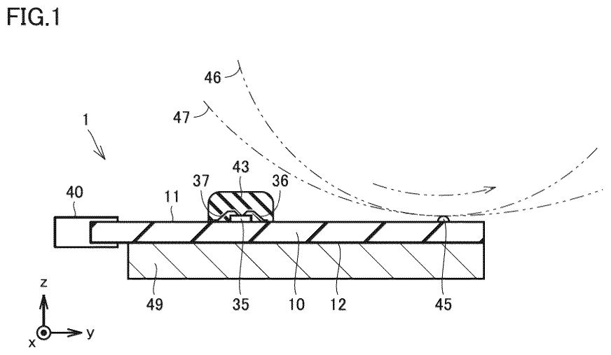

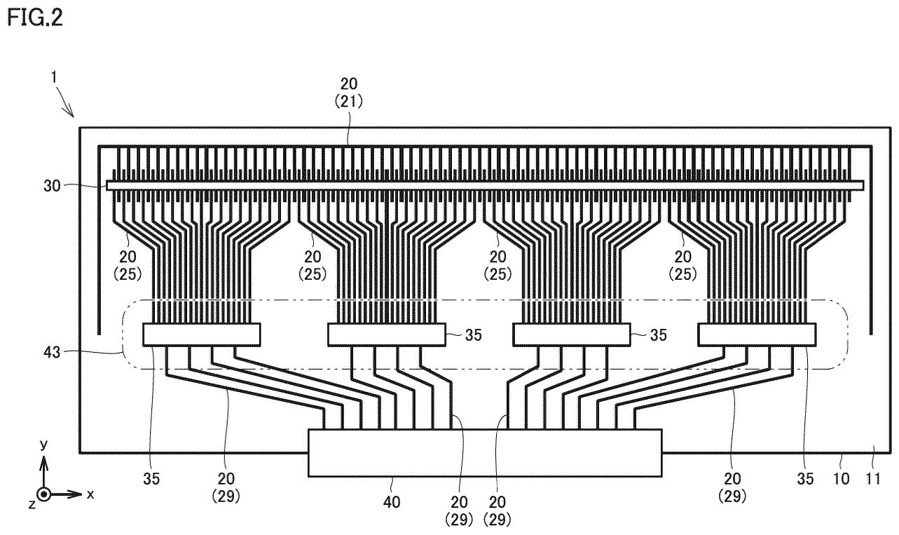

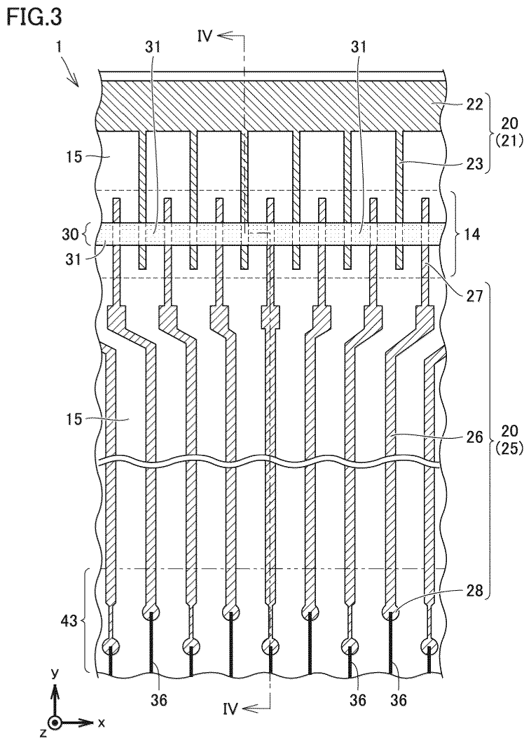

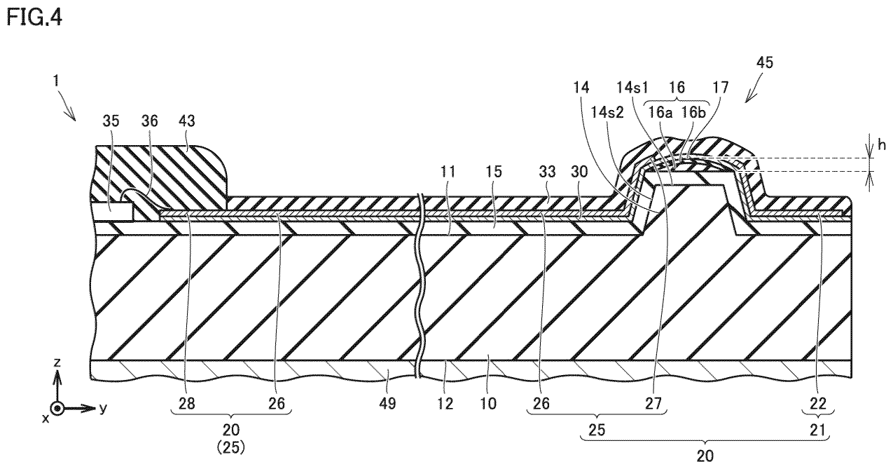

FIG. 1 is a schematic cross-sectional view of a thermal print head 1 according to the first embodiment. FIG. 2 is a schematic plan view of thermal print head 1 according to the first embodiment. FIG. 3 is a partially enlarged schematic plan view of thermal print head 1 according to the first embodiment. FIG. 4 is a partially enlarged schematic cross-sectional view of thermal print head 1 according to the first embodiment.

Thermal print head 1 is an electronic device that makes printing on a print medium 47 such as heat-sensitive paper by causing a plurality of heat generation portions 31 (see FIG. 3) to selectively generate heat. Thermal print head 1 mainly includes a substrate 10, an insulating layer 15, a wiring layer 20, a resistor layer 30, a protective layer 33, a drive circuit 35, conductive wires 36 and 37, a connector 40, a sealing member 43, and a heat sink 49.

As shown in FIG. 4, substrate 10 has a main surface 11 and a rear surface 12 opposite to main surface 11. Main surface 11 and rear surface 12 each extend in an x direction and a y direction perpendicular to the x direction. The x direction corresponds to a long-side direction of substrate 10 and also corresponds to a main scanning direction of thermal print head 1. The y direction corresponds to a short-side direction of substrate 10 and also corresponds to a sub-scanning direction of thermal print head 1. The z direction corresponds to a thickness direction of substrate 10. The direction of the normal to main surface 11 corresponds to a z direction perpendicular to the x direction and the y direction. Main surface 11 faces in a +z direction. Rear surface 12 faces in a −z direction. The material forming substrate 10 is silicon.

As shown in FIGS. 3 and 4, substrate 10 has a protruding portion 14 on main surface 11. As will be described later, protruding portion 14 is formed, for example, by wet etching with a potassium hydroxide (KOH) aqueous solution. In particular, when protruding portion 14 is formed by wet etching, the material forming substrate 10 is preferably silicon. In a plan view of main surface 11, the long-side direction of protruding portion 14 corresponds to the x direction, and the short-side direction thereof corresponds to the y direction. A height direction of protruding portion 14 corresponds to the z direction.

Protruding portion 14 has a top surface 14s1 and a pair of inclined surfaces 14s2. Top surface 14s1 is farthest from main surface 11 in the z direction. Top surface 14s1 may extend in the x direction and the y direction. The pair of inclined surfaces 14s2 are spaced apart from each other in the y direction. The pair of inclined surfaces 14s2 connect main surface 11 and top surface 14s1. The pair of inclined surfaces 14s2 are inclined with respect to main surface 11 so as to come close to each other from main surface 11 to top surface 14s1. The pair of inclined surfaces 14s2 are each inclined with respect to main surface 11, for example, at an inclination angle θ of 54.7°.

Substrate 10 having protruding portion 14 contains a single crystal of silicon (Si). In the crystal structure of substrate 10, the plane orientation of each of main surface 11 and rear surface 12 is a (100) plane. The plane orientation of each of the pair of inclined surfaces 14s2 is a (111) plane.

As shown in FIGS. 3 and 4, insulating layer 15 is disposed on at least a part of main surface 11 and protruding portion 14, and covers at least a part of main surface 11 and protruding portion 14. Insulating layer 15 may cover the entire main surface 11.

The material forming insulating layer 15 is an oxide film of silicon dioxide (SiO₂) or the like. An oxide film of silicon dioxide or the like is formed, for example, by thermal oxidation.

An oxide film (a TEOS oxide film) formed, for example, with tetraethyl orthosilicate (TEOS) may be disposed on the oxide film formed by thermal oxidation. A TEOS oxide film is formed by stacking thin films of silicon dioxide several times by a plasma CVD (chemical vapor deposition) method. The silicon dioxide is formed with tetraethyl orthosilicate serving as a source gas. The thickness of the TEOS oxide film in the z direction is, for example, 2.5 μm.

Substrate 10 is electrically insulated by insulating layer 15 from resistor layer 30 and wiring layer 20. The thickness of insulating layer 15 in the z direction is, for example, 1 μm or more and 15 μm or less. On top surface 14s1 of protruding portion 14, a glaze layer 16 including hollow fillers 16c is formed on insulating layer 15. Glaze layer 16 will be described later in detail.

Resistor layer 30 is formed on insulating layer 15 and glaze layer 16. Resistor layer 30 is connected to insulating layer 15 and glaze layer 16. Resistor layer 30 is formed of a material higher in electrical resistivity than wiring layer 20 to be described later. The material forming resistor layer 30 is, for example, tantalum nitride (TaN). Resistor layer 30 is formed by sputtering. From the viewpoint of strength, the material forming resistor layer 30 may be polysilicon. The thickness of resistor layer 30 in the z direction is, for example, 0.02 μm or more and 0.1 μm or less. The thickness of resistor layer 30 in the z direction may be 50 nm.

As shown in FIGS. 2 to 4, wiring layer 20 is connected to resistor layer 30. Wiring layer 20 forms a conductive path via which a current flows through the plurality of heat generation portions 31 of resistor layer 30. Wiring layer 20 is electrically conductive with the plurality of heat generation portions 31. Wiring layer 20 may be made, for example, of a conductive material containing at least one of titanium (Ti) and copper (Cu). Wiring layer 20 may be made of aluminum (Al).

Wiring layer 20 includes a common wiring line 21, a plurality of individual wiring lines 25, and a plurality of lead-out wiring lines 29. The plurality of individual wiring lines 25 are located apart from common wiring line 21 and the plurality of lead-out wiring lines 29. In order to cause the plurality of heat generation portions 31 to selectively generate heat, a current flows from common wiring line 21 toward the plurality of individual wiring lines 25 through the plurality of heat generation portions 31.

Common wiring line 21 is electrically conductive with the plurality of heat generation portions 31. Specifically, as shown in FIGS. 3 and 4, common wiring line 21 includes a base portion 22 and a plurality of extension portions 23. In a plan view of main surface 11, base portion 22 is disposed on one side (a +y side) in the y direction with respect to resistor layer 30. The long-side direction of base portion 22 corresponds to the x direction, and the short-side direction thereof corresponds to the y direction. Base portion 22 is located apart from resistor layer 30 in the y direction. The plurality of extension portions 23 extend in a −y direction from base portion 22 toward resistor layer 30. The plurality of extension portions 23 are arranged at equal intervals in the x direction.

Each of the plurality of individual wiring lines 25 is electrically conductive with a corresponding one of the plurality of heat generation portions 31. Specifically, as shown in FIGS. 3 and 4, the plurality of individual wiring lines 25 are arranged in the x direction. Each of the plurality of individual wiring lines 25 includes a terminal portion 28 and an extension portion 26.

In a plan view of main surface 11, terminal portion 28 is disposed on the other side (a −y side) in the y direction with respect to resistor layer 30. Terminal portion 28 is disposed on the side opposite to base portion 22 of common wiring line 21 in the y direction with respect to resistor layer 30. As shown in FIGS. 1 and 3, conductive wire 36 is bonded to terminal portion 28 and drive circuit 35. Terminal portion 28 is electrically connected to drive circuit 35 through conductive wire 36.

Extension portion 26 is connected to terminal portion 28. An end portion 27 of extension portion 26 that is opposite to terminal portion 28 is in contact with resistor layer 30. In a plan view of main surface 11, end portion 27 of extension portion 26 overlaps with protruding portion 14.

As shown in FIG. 2, in the plan view of main surface 11, the plurality of lead-out wiring lines 29 are disposed on the other side (the −y side) in the y direction with respect to drive circuit 35. In the plan view of main surface 11, the plurality of lead-out wiring lines 29 are disposed on the side opposite to resistor layer 30 and the plurality of individual wiring lines 25 with respect to drive circuit 35. Conductive wire 37 is bonded to drive circuit 35 and the plurality of lead-out wiring lines 29. The plurality of lead-out wiring lines 29 are electrically connected to drive circuit 35 through conductive wire 37. The plurality of lead-out wiring lines 29 are connected to connector 40.

As shown in FIG. 4, resistor layer 30 is connected on insulating layer 15. In the direction of the normal to main surface 11 (the z direction), resistor layer 30 is disposed on the side opposite to substrate 10 with respect to insulating layer 15. In the plan view of main surface 11, the long-side direction of resistor layer 30 corresponds to the x direction, and the short-side direction thereof corresponds to the y direction. In the plan view of main surface 11, resistor layer 30 intersects the plurality of extension portions 23 of common wiring line 21 and end portions 27 of extension portions 26 of the plurality of individual wiring lines 25. Resistor layer 30 extends over the plurality of extension portions 23 of common wiring line 21 and end portions 27 of extension portions 26 of the plurality of individual wiring lines 25.

Resistor layer 30 includes the plurality of heat generation portions 31. One of the plurality of heat generation portions 31 corresponds to a region of resistor layer 30 that is sandwiched between: one portion covered by one of the plurality of extension portions 23 of common wiring line 21; and another portion covered by one of end portions 27 of the plurality of individual wiring lines 25 that is adjacent to the one portion in the x direction. The plurality of heat generation portions 31 are connected to insulating layer 15. The plurality of heat generation portions 31 are arranged in the x direction. In the plan view of main surface 11, the plurality of heat generation portions 31 overlap with protruding portion 14. In the plan view of main surface 11, the plurality of heat generation portions 31 are disposed inside protruding portion 14 in the short-side direction (the y direction) of resistor layer 30.

As shown in FIG. 4, protective layer 33 covers resistor layer 30, wiring layer 20, and the plurality of heat generation portions 31. Protective layer 33 is connected to resistor layer 30, wiring layer 20, and the plurality of heat generation portions 31. A portion (for example, terminal portion 28 or the like) of wiring layer 20 to which conductive wires 36 and 37 are bonded is exposed from protective layer 33. The material forming protective layer 33 may be, for example, at least one of silicon dioxide, silicon nitride (SiN), and silicon carbide (SiC). Protective layer 33 may be formed by a CVD method. The thickness of protective layer 33 in the z direction may be, for example, 3.2 μm.

Drive circuit 35 is mounted on main surface 11. For example, drive circuit 35 is fixed to insulating layer 15 with a bonding member (not shown) such as an adhesive. Drive circuit 35 may be mounted on a wiring board (not shown) separated from substrate 10. The wiring board is, for example, a printed circuit board (PCB). Drive circuit 35 is electrically connected to wiring layer 20 (specifically, the plurality of individual wiring lines 25 and the plurality of lead-out wiring lines 29). Drive circuit 35 applies a current to the plurality of heat generation portions 31 individually through the plurality of individual wiring lines 25. Among the plurality of heat generation portions 31, heat generation portions 31 to which a current is applied selectively generate heat.

As shown in FIGS. 1 and 2, connector 40 is disposed on the side opposite to resistor layer 30 in the y direction with respect to drive circuit 35. Connector 40 is attached, for example, to an end portion of substrate 10 in the y direction. Connector 40 is electrically connected to drive circuit 35 through wiring layer 20 (specifically, the plurality of lead-out wiring lines 29). For example, connector 40 includes a plurality of pins (not shown). Some of the plurality of pins are electrically conductive with the plurality of lead-out wiring lines 29. Another some of the plurality of pins are electrically conductive with a wiring line (not shown) that is electrically conductive with base portion 22 of common wiring line 21. Connector 40 is connected to a thermal printer. A constant voltage is applied from the thermal printer to common wiring line 21 through connector 40.

As shown in FIGS. 1 and 4, sealing member 43 covers drive circuit 35 and seals drive circuit 35. Sealing member 43 further covers conductive wires 36 and 37, and further seals conductive wires 36 and 37. Sealing member 43 further covers a portion (for example, terminal portion 28 or the like) of each of the plurality of individual wiring lines 25 that is exposed from protective layer 33. Sealing member 43 has electrical insulation properties. Sealing member 43 is formed, for example, of an insulating resin material such as an epoxy resin.

As shown in FIG. 1, heat sink 49 is disposed on the side opposite to insulating layer 15 and resistor layer 30 in the z direction with respect to substrate 10. Heat sink 49 is attached to rear surface 12 of substrate 10 by a fastening member such as a screw or a bonding member (not shown). Heat sink 49 supports substrate 10. Heat sink 49 is formed, for example, of a highly thermally conductive material such as aluminum (Al). Part of the heat generated from the plurality of heat generation portions 31 of resistor layer 30 is transmitted to heat sink 49 through substrate 10. The heat transmitted to heat sink 49 is dissipated to the outside of thermal print head 1. Heat sink 49 can prevent an excessive rise in temperature of substrate 10. When drive circuit 35 is mounted on a wiring board different from substrate 10, heat sink 49 supports substrate 10 and the wiring board.

As shown in FIGS. 1 and 4, thermal print head 1 includes a protrusion 45 formed on main surface 11. Protrusion 45 includes protruding portion 14, insulating layer 15, glaze layer 16, wiring layer 20, the plurality of heat generation portions 31, and protective layer 33. In protrusion 45, protruding portion 14, insulating layer 15, glaze layer 16, resistor layer 30, wiring layer 20, the plurality of heat generation portions 31, and protective layer 33 are stacked in this order on main surface 11 in the direction of the normal to main surface 11 (the z direction).

Herein, thermal print head 1 according to the present first embodiment is characterized in that glaze layer 16 including hollow fillers 16c is disposed on main surface 11, as shown in FIG. 4. Hollow filler 16c is a granular member surrounding a region V having a low thermal conductivity. Hollow filler 16c has a spherical shape, for example. Hollow filler 16c can be made of any material, which is, for example, glass. Regarding region V having a low thermal conductivity, for example, region V may be filled with air. It is preferable that the inside of region V is particularly under vacuum.

Glaze layer 16 suppresses dissipation of the heat generated in heat generation portion 31 and improves the heat storage properties of thermal print head 1. In particular, due to glaze layer 16 including hollow fillers 16c described above, thermal print head 1 is further improved in heat storage properties. Improving the heat storage properties makes it possible to reduce the amount of the current flowing during printing on print medium 47.

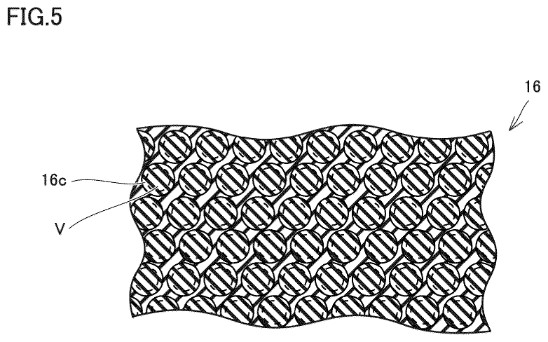

FIG. 5 is a schematic cross-sectional view of glaze layer 16 including hollow fillers 16c. As shown in FIG. 5, glaze layer 16 includes hollow fillers 16c. As described above, hollow filler 16c includes region V that is hollow. Such hollow fillers 16c are scattered in glaze layer 16. If each hollow filler 16c has a spherical shape, the diameter of hollow filler 16c may be 10 μm or less, and is preferably 1 μm or less. As each hollow filler 16c is smaller, a larger number of hollow fillers 16c can be included in glaze layer 16. Thus, the void ratio (an air region or a vacuum region) of glaze layer 16 increases, so that the heat storage properties of thermal print head 1 are improved.

From a different point of view, in order to improve the heat storage properties of thermal print head 1, the volume content of hollow fillers 16c in glaze layer 16 may be 50% or more, may be 80% or more, and is more preferably 90% or more.

As described above, the material forming hollow filler 16c is preferably a material having a low thermal conductivity and capable of ensuring strength. Further, it is preferable that the material forming hollow filler 16c has a high melting point in order not to be melted by the heat during manufacturing of thermal print head 1 to be described later. In particular, the melting point of the material forming hollow filler 16c is preferably 800° C. or more. As such a material, the material forming hollow filler 16c is preferably glass, and particularly preferably quartz glass.

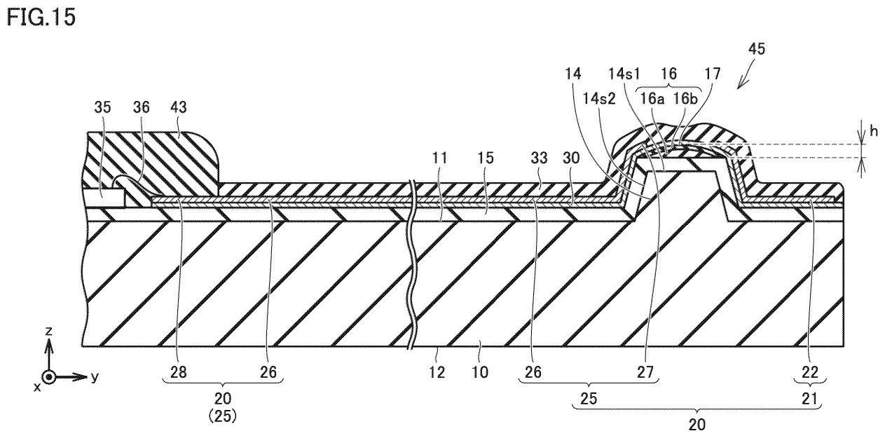

As shown in FIG. 4, in a cross-sectional view of thermal print head 1, glaze layer 16 is disposed between resistor layer 30 and insulating layer 15. In order to improve the heat storage properties of thermal print head 1, it is only necessary to suppress the heat generated in resistor layer 30 from flowing through substrate 10 and being dissipated. Thus, glaze layer 16 should only be disposed between resistor layer 30 and substrate 10. For example, as will be described later in the second embodiment, glaze layer 16 may be disposed directly on substrate 10. In other words, glaze layer 16 may be disposed between insulating layer 15 and main surface 11 (see FIG. 15).

In a plan view of main surface 11 as seen in the z direction, glaze layer 16 is disposed so as to cover top surface 14s1 of protruding portion 14 of main surface 11. As shown in FIG. 4, glaze layer 16 is disposed so as to be sandwiched between the pair of inclined surfaces 14s2 in the y direction.

Glaze layer 16 includes a first glaze layer 16a and a second glaze layer 16b. Hollow fillers 16c are included in first glaze layer 16a. First glaze layer 16a is connected to insulating layer 15. Second glaze layer 16b is disposed on first glaze layer 16a. Second glaze layer 16b is connected to resistor layer 30.

As will be described later, when first glaze layer 16a including hollow fillers 16c is formed, a glaze having fluidity is applied. Thus, in a cross-sectional view of thermal print head 1 as shown in FIG. 4, a portion of intersection between top surface 14s1 and inclined surface 14s2 is preferably not formed as a curved line, but is preferably formed, for example, as a corner portion where two straight lines intersect with each other. This allows a glaze to be applied onto top surface 14s1 of protruding portion 14 with the help of the surface tension of the glaze. In order to form protruding portion 14 having the corner portion as described above, the material forming substrate 10 is preferably silicon. Then, the glaze is dried. In this way, first glaze layer 16a including hollow fillers 16c can be formed.

Second glaze layer 16b is formed on first glaze layer 16a. Second glaze layer 16b is formed by glaze printing. Then, glaze layer 16 is formed by firing. Glaze layer 16 thus formed has a curved surface portion 17. Curved surface portion 17 is a surface of glaze layer 16 that is farthest from substrate 10 in the z direction. In thermal print head 1 according to the present first embodiment, curved surface portion 17 is a surface connected to resistor layer 30. In a plan view seen in the z direction, curved surface portion 17 overlaps with protruding portion 14.

A thickness h of glaze layer 16 in the z direction is, for example, 20 μm or more and 250 μm or less, and can be changed as appropriate depending on the width of top surface 14s1 in the y direction. As thickness h is larger, thermal print head 1 is improved more in heat storage properties.

### Method of Manufacturing Thermal Print Head

Hereinafter, a method of manufacturing thermal print head 1 according to the present embodiment will be described.

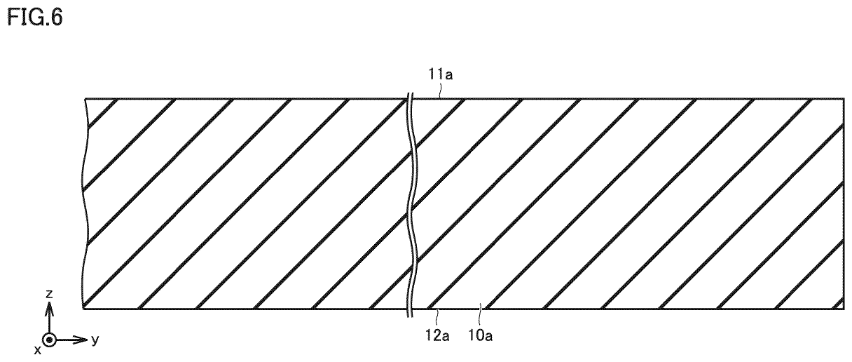

First, a step (S1a) of preparing a wafer 10a is performed. In this step (S1a), as shown in FIG. 6, wafer 10a as a silicon substrate that is a semiconductor material is prepared. Wafer 10a contains a single crystal of silicon.

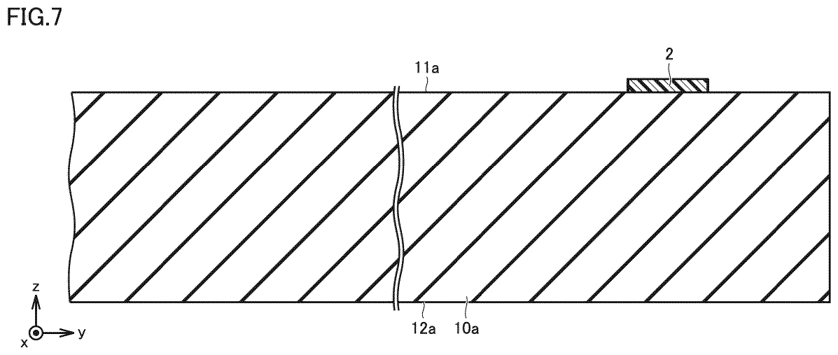

Then, a step (S2a) of forming mask layer 2 is performed. In this step (S2a), as shown in FIG. 7, mask layer 2 is formed in a region of main surface 11a where protruding portion 14 is to be formed. The material forming mask layer 2 is, for example, silicon nitride (SiN) or silicon dioxide (SiO₂). Mask layer 2 is formed by a CVD method or by sputtering.

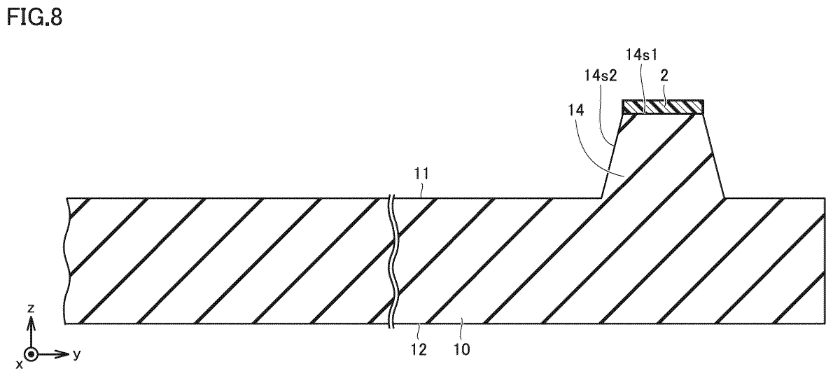

Then, a step (S3a) of etching is performed. In this step (S3a), as shown in FIG. 8, wafer 10a is wet-etched with mask layer 2 serving as a mask. In a plan view seen in the z direction, wafer 10a in a region not provided with mask layer 2 is etched in the −z direction. For example, wet etching is performed using a potassium hydroxide (KOH) aqueous solution serving as an etching solution. In this way, substrate 10 is formed. Further, wafer 10a is not etched in a region provided with mask layer 2. Thus, protruding portion 14 is formed on main surface 11 of substrate 10.

When an alkaline aqueous solution such as a potassium hydroxide (KOH) aqueous solution is used as an etching solution, wafer 10a is etched such that inclination angle θ of inclined surface 14s2 with respect to main surface 11 is 54.7°. After protruding portion 14 shown in FIG. 8 is formed, mask layer 2 is removed by wet etching with hydrofluoric acid (HF).

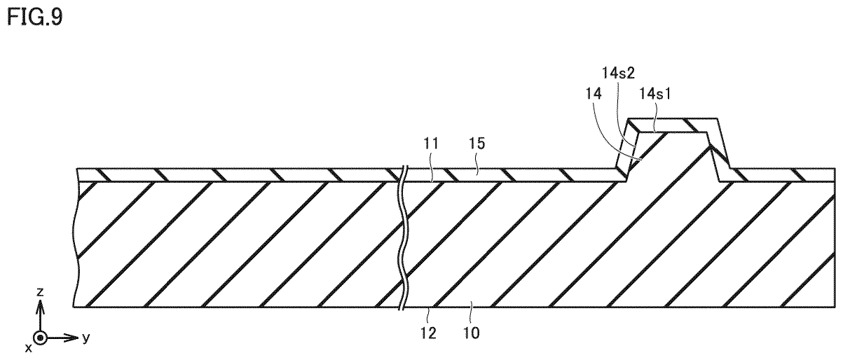

Then, a step (S4a) of forming insulating layer 15 is performed. In this step (S4a), as shown in FIG. 9, insulating layer 15 is formed that covers at least a part of main surface 11 and protruding portion 14. Specifically, insulating layer 15 is formed by thermal oxidation. A TEOS oxide film may be formed by stacking, by a plasma CVD method, thin films of silicon dioxide several times on an oxide film formed by thermal oxidation.

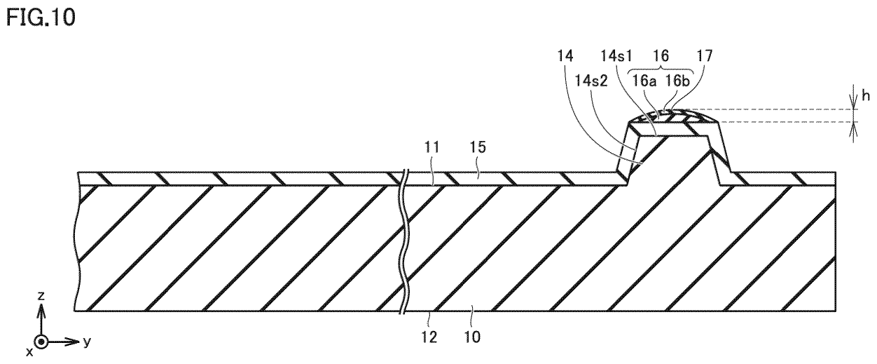

Then, a step (S5a) of forming glaze layer 16 is performed. In this step (S5a), as shown in FIG. 10, glaze layer 16 is formed on insulating layer 15. Specifically, a glaze containing hollow fillers 16c is applied onto top surface 14s1 of protruding portion 14. Then, the glaze is dried. In this way, first glaze layer 16a including hollow fillers 16c is formed.

Then, a glaze is applied onto first glaze layer 16a by glaze printing. Thus, second glaze layer 16b is formed. Then, glaze layer 16 is formed by firing.

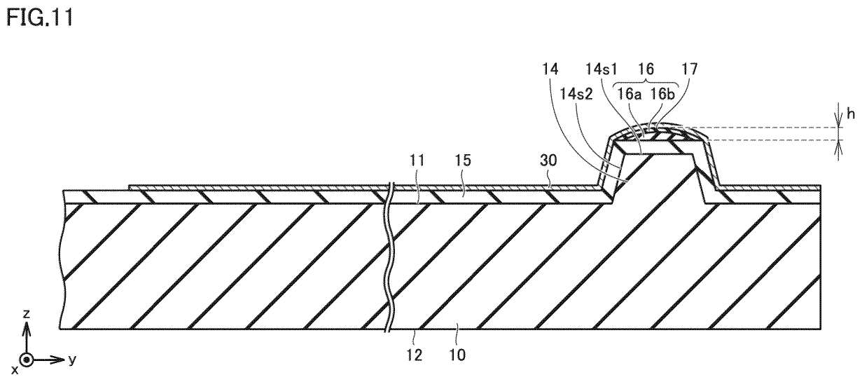

Then, a step (S6a) of forming resistor layer 30 is performed. In this step (S6a), as shown in FIG. 11, resistor layer 30 is formed on insulating layer 15. Specifically, resistor layer 30 is formed by sputtering. The material forming resistor layer 30 is, for example, tantalum nitride (TaN). The material forming resistor layer 30 may be polysilicon. Resistor layer 30 includes a plurality of heat generation portions 31.

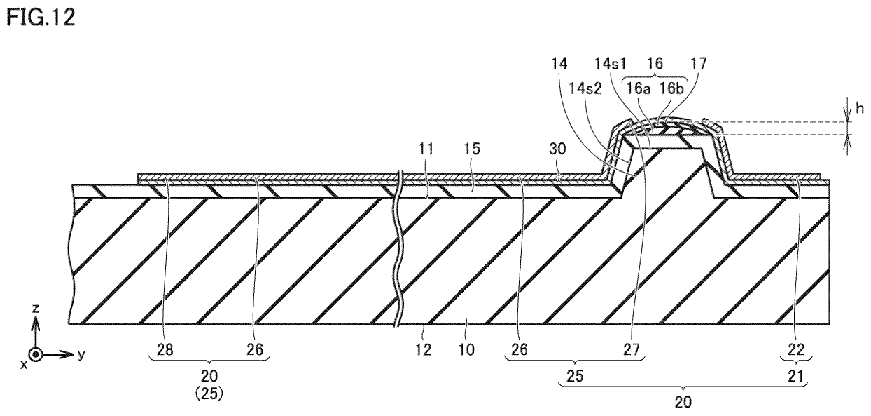

Then, a step (S7a) of forming wiring layer 20 is performed. In this step (S7a), as shown in FIG. 12, wiring layer 20 is formed on resistor layer 30. Specifically, wiring layer 20 is formed by sputtering. Wiring layer 20 may be formed by stacking thin films of copper several times, for example, by sputtering. By using sputtering, a thin film of titanium may be stacked on resistor layer 30, on which thin films of copper may thereafter be stacked several times, to thereby form wiring layer 20. Wiring layer 20 may be formed not by stacking thin films of titanium and thin films of copper, but by stacking thin films of aluminum.

After wiring layer 20 is formed, lithography patterning is performed to remove a part of wiring layer 20. Specifically, a mask layer is formed on wiring layer 20 by photolithography. Wiring layer 20 is partially removed by etching with the mask layer serving as a mask. Wiring layer 20 can be etched by wet etching. A mixed solution of sulfuric acid (H₂SO₄) and hydrogen peroxide (H₂O₂) is used for wet etching. Thereby, as shown in FIG. 3, common wiring line 21 and the plurality of individual wiring lines 25 are formed on resistor layer 30. As shown in FIG. 12, a part of resistor layer 30 is exposed from wiring layer 20. Then, a part of resistor layer 30 is etched by reactive ion etching. Thereby, as shown in FIG. 3, insulating layer 15 is exposed on protruding portion 14. The plurality of heat generation portions 31 are exposed on top surface 14s1 of protruding portion 14.

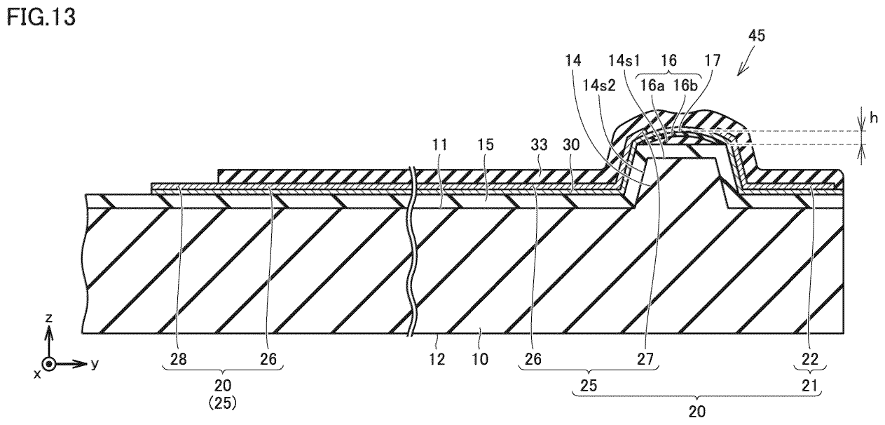

Then, a step (S8a) of forming protective layer 33 is performed. Specifically, as shown in FIG. 13, protective layer 33 is formed by plasma CVD on insulating layer 15, the plurality of heat generation portions 31, and a part of wiring layer 20. Protective layer 33 is formed by stacking thin films of silicon nitride. A portion (for example, terminal portion 28 or the like) of wiring layer 20 to which conductive wires 36 and 37 are bonded is exposed from protective layer 33.

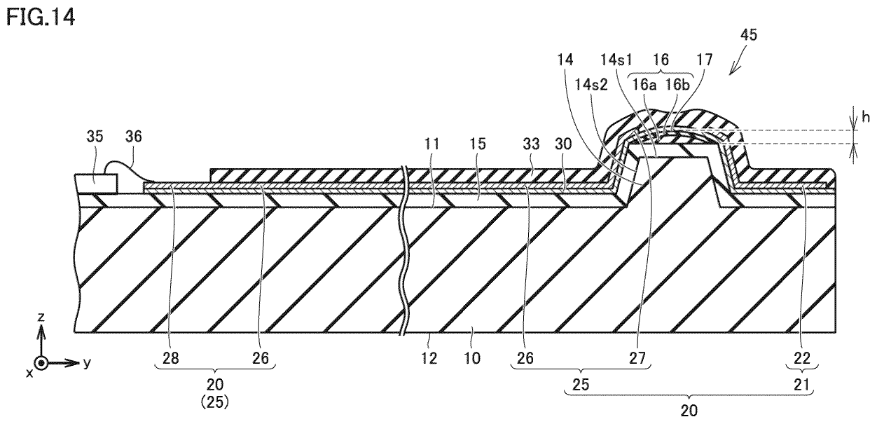

Then, a step (S9a) of mounting drive circuit 35 is performed. In this step (S9a), as shown in FIG. 14, drive circuit 35 is mounted on main surface 11. For example, drive circuit 35 is fixed to insulating layer 15 with a bonding member (not shown) such as an adhesive. As shown in FIG. 14, conductive wires 36 and 37 are bonded. For example, conductive wire 36 is bonded with a wire bonder (not shown) to drive circuit 35 and terminal portions 28 of the plurality of individual wiring lines 25. Conductive wire 37 is bonded with a wire bonder (not shown) to drive circuit 35 and the plurality of lead-out wiring lines 29.

Then, a step (S10a) of sealing is performed. In this step (S10a), as shown in FIG. 15, drive circuit 35 is sealed with sealing member 43. For example, potting of a sealing resin material is done on drive circuit 35. Thereafter, the sealing resin material is hardened. Thus, sealing member 43 is formed.

Then, connector 40 is attached to substrate 10. Connector 40 includes a plurality of pins (not shown). Some of the plurality of pins are electrically conductive with the plurality of lead-out wiring lines 29. Another some of the plurality of pins are electrically conductive with a wiring line (not shown) electrically conductive with base portion 22 of common wiring line 21.

Then, heat sink 49 is attached to substrate 10. Specifically, heat sink 49 is attached to rear surface 12 of substrate 10 by a fastening member such as a screw or a bonding member (not shown). Thus, thermal print head 1 in the present embodiment as shown in FIGS. 1 to 4 is obtained.

The operation of thermal print head 1 in the present embodiment will be described.

As shown in FIG. 1, protrusion 45 faces a platen roller 46 included in the thermal printer. Platen roller 46 feeds print medium 47 toward thermal print head 1. Platen roller 46 rotates to cause print medium 47 to be fed in the +y direction. Print medium 47 is sandwiched between protrusion 45 and platen roller 46.

Drive circuit 35 applies a current to the plurality of heat generation portions 31 individually through the plurality of individual wiring lines 25. Among the plurality of heat generation portions 31, heat generation portions 31 to which a current is applied selectively generate heat. The heat generated by heat generation portions 31 is transmitted to print medium 47. In this way, printing is made on print medium 47 using thermal print head 1. Glaze layer 16 includes hollow fillers 16c. Hollow fillers 16c each include vacuum region V having a low thermal conductivity. Thus, dissipation of part of the heat generated in the plurality of heat generation portions 31 is suppressed by glaze layer 16. The remainder of the heat generated in the plurality of heat generation portions 31 is released to the outside of thermal print head 1 through substrate 10 and heat sink 49.

### Functions and Effects

Thermal print head 1 according to the present disclosure includes substrate 10 and glaze layer 16. Substrate 10 has main surface 11. Glaze layer 16 is disposed on main surface 11. Glaze layer 16 includes hollow fillers 16c.

In this way, due to glaze layer 16 including hollow fillers 16c, the heat storage properties of thermal print head 1 are improved. Improving the heat storage properties makes it possible to reduce the amount of the current flowing during printing on print medium 47.

In thermal print head 1, the volume content of hollow fillers 16c in glaze layer 16 is 50% or more. In this way, thermal print head 1 having sufficiently improved heat storage properties is obtained. Improving the heat storage properties makes it possible to reduce the amount of the current flowing during printing on print medium 47.

In thermal print head 1, hollow filler 16c contains glass. In this way, the heat storage properties and the strength of glaze layer 16 can be ensured. Further, melting of hollow fillers 16c by heat during manufacturing of thermal print head 1 can be suppressed.

In thermal print head 1, the material forming substrate 10 is silicon. Thereby, when protruding portion 14 is formed by wet etching with a potassium hydroxide (KOH) aqueous solution, protruding portion 14 is formed by a straight line in a cross-sectional view of protruding portion 14. Consequently, a glaze having fluidity can be applied onto top surface 14s1 with the help of the surface tension.

In thermal print head 1, protruding portion 14 is formed on main surface 11. Glaze layer 16 covers top surface 14s1 of protruding portion 14. In this way, the heat generated in heat generation portion 31 is suppressed from being dissipated to substrate 10. Consequently, the heat storage properties of thermal print head 1 are improved.

In thermal print head 1, glaze layer 16 has curved surface portion 17. The direction perpendicular to main surface 11 is defined as a z direction. In a plan view seen in the z direction, curved surface portion 17 overlaps with protruding portion 14. Thus, heat generation portion 31 is formed on protruding portion 14 to thereby allow heat generation portion 31 to have a curved surface.

In thermal print head 1, thickness h of glaze layer 16 in the z direction is 20 μm or more and 250 μm or less. In this way, the heat storage properties of thermal print head 1 are improved. In particular, as thickness h is larger, thermal print head 1 is improved more in heat storage properties.

Thermal print head 1 further includes insulating layer 15 and resistor layer 30. Insulating layer 15 is disposed on main surface 11. Resistor layer 30 is disposed on insulating layer 15. Glaze layer 16 is located between main surface 11 and resistor layer 30. In this way, the heat generated in resistor layer 30 is suppressed from being dissipated to substrate 10. In particular, dissipation of the heat generated in heat generation portion 31 is suppressed. Consequently, the heat storage properties of thermal print head 1 are improved. Improving the heat storage properties makes it possible to reduce the amount of the current flowing during printing on print medium 47.

In thermal print head 1, glaze layer 16 is disposed between resistor layer 30 and insulating layer 15. In this way, the heat generated in resistor layer 30 is suppressed from being dissipated to substrate 10. In particular, dissipation of the heat generated in heat generation portion 31 is suppressed.

### Second Embodiment

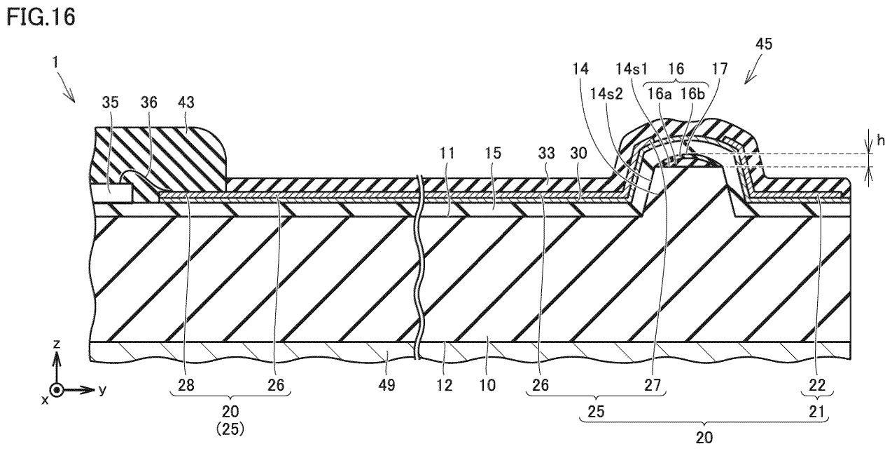

FIG. 16 is a partially enlarged schematic cross-sectional view of thermal print head 1 according to the second embodiment. FIG. 16 corresponds to FIG. 4. Thermal print head 1 shown in FIG. 16 basically has the same configuration and can achieve the same effects as those of thermal print head 1 shown in FIGS. 1 to 4, but is different from thermal print head 1 shown in FIGS. 1 to 4 in that glaze layer 16 is disposed directly on substrate 10. In other words, glaze layer 16 may be disposed between insulating layer 15 and main surface 11. Even with such a configuration, thermal print head 1 having sufficiently improved heat storage properties is obtained. Improving the heat storage properties makes it possible to reduce the amount of the current flowing during printing on print medium 47.

### Method of Manufacturing Thermal Print Head

Hereinafter, a method of manufacturing thermal print head 1 according to the present second embodiment will be described.

First, steps similar to those shown in FIGS. 6 to 8 in the method of manufacturing thermal print head 1 according to the first embodiment are performed. Specifically, a step (S1b) of preparing wafer 10a is first performed. In this step (S1b), as shown in FIG. 6, wafer 10a as a silicon substrate that is a semiconductor material is prepared. Wafer 10a contains a single crystal of silicon.

Then, a step (S2b) of forming mask layer 2 is performed. In this step (S2b), as shown in FIG. 7, mask layer 2 is formed in a region of main surface 11a where protruding portion 14 is to be formed. The material forming mask layer 2 is, for example, silicon nitride (SiN) or silicon dioxide (SiO₂). Mask layer 2 is formed by a CVD method or by sputtering.

Then, a step (S3b) of etching is performed. In this step (S3b), as shown in FIG. 8, wafer 10a is wet-etched with mask layer 2 serving as a mask. In a plan view seen in the z direction, wafer 10a in a region not provided with mask layer 2 is etched in the −z direction. For example, wet etching is performed using a potassium hydroxide (KOH) aqueous solution as an etching solution. In this way, substrate 10 is formed. Further, wafer 10a is not etched in the region provided with mask layer 2. Thus, protruding portion 14 is formed on main surface 11 of substrate 10.

When an alkaline aqueous solution such as a potassium hydroxide (KOH) aqueous solution is used as an etching solution, wafer 10a is etched such that inclination angle θ of inclined surface 14s2 with respect to main surface 11 is 54.7°. After protruding portion 14 shown in FIG. 8 is formed, mask layer 2 is removed by wet etching with hydrofluoric acid (HF).

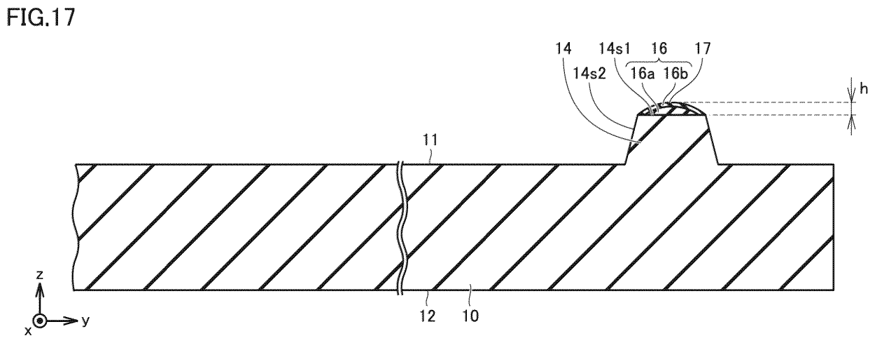

Then, a step (S4b) of forming glaze layer 16 is performed. In this step (S4b), as shown in FIG. 17, glaze layer 16 is formed on top surface 14s1 of substrate 10. Specifically, a glaze containing hollow fillers 16c is applied onto top surface 14s1 of protruding portion 14. Then, the glaze is dried. In this way, first glaze layer 16a including hollow fillers 16c is formed.

Then, a glaze is applied onto first glaze layer 16a by glaze printing. Thus, second glaze layer 16b is formed. Then, glaze layer 16 is formed by firing.

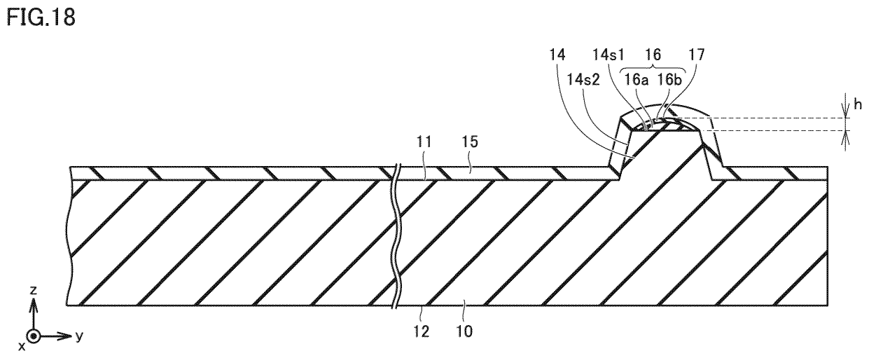

Then, a step (S5b) of forming insulating layer 15 is performed. In this step (S5a), as shown in FIG. 18, insulating layer 15 is formed that covers at least a part of main surface 11, at least a part of protruding portion 14, and glaze layer 16. Specifically, insulating layer 15 is formed by thermal oxidation. A TEOS oxide film may be formed by stacking, by a plasma CVD method, thin films of silicon dioxide several times on an oxide film formed by thermal oxidation.

After the step (S5b) of forming insulating layer 15, the step (S6a) of forming resistor layer 30 to the step (S10a) of sealing, which are shown in FIGS. 11 to 15, are sequentially performed. Thus, thermal print head 1 according to the present second embodiment is manufactured.

### Functions and Effects

In thermal print head 1, glaze layer 16 is disposed between insulating layer 15 and main surface 11. In this way, thermal print head 1 having improved heat storage properties is obtained. Improving the heat storage properties makes it possible to reduce the amount of the current flowing during printing on print medium 47.

Hereinafter, various configurations of the present disclosure will be summarized as additional aspects.

### Additional Aspect 1

A thermal print head comprising:
a substrate having a main surface; and
a glaze layer disposed on the main surface, wherein
the glaze layer includes a hollow filler.

### Additional Aspect 2

The thermal print head according to Additional Aspect 1, wherein the hollow filler contains glass.

### Additional Aspect 3

The thermal print head according to Additional Aspect 1 or 2, wherein a material forming the substrate is silicon.

### Additional Aspect 4

The thermal print head according to Additional Aspect 3, wherein
the main surface is provided with a protruding portion, and
the glaze layer covers a top surface of the protruding portion.

### Additional Aspect 5

The thermal print head according to Additional Aspect 4, wherein
the glaze layer has a curved surface portion, and
when a direction perpendicular to the main surface is defined as a z direction,
the curved surface portion overlaps with the protruding portion in a plan view seen in the z direction.

### Additional Aspect 6

The thermal print head according to Additional Aspect 5, wherein a thickness of the glaze layer in the z direction is 20 μm or more and 250 μm or less.

### Additional Aspect 7

The thermal print head according to any one of Additional Aspects 1 to 6, further comprising:
an insulating layer; and
a resistor layer, wherein
the insulating layer is disposed on the main surface,
the resistor layer is disposed on the insulating layer, and
the glaze layer is located between the main surface and the resistor layer.

### Additional Aspect 8

The thermal print head according to Additional Aspect 7, wherein the glaze layer is disposed between the resistor layer and the insulating layer.

### Additional Aspect 9

The thermal print head according to Additional Aspect 7, wherein the glaze layer is disposed between the insulating layer and the main surface.

It should be understood that the embodiments disclosed herein are illustrative and non-restrictive in every respect. The basic scope of the present disclosure is defined by the terms of the claims, rather than the description above, and is intended to include any modifications within the scope and meaning equivalent to the terms of the claims.

### REFERENCE SIGNS LIST

1 thermal print head, 2 mask layer, 10 substrate, 10a wafer, 11, 11a main surface, 12, 12a rear surface, 14 protruding portion, 14s1 top surface, 14s2 inclined surface, 15 insulating layer, 16 glaze layer, 16a first glaze layer, 16b second glaze layer, 16c hollow filler, 17 curved surface portion, 20 wiring layer, 21 common wiring line, 22 base portion, 23, 26 extension portion, 25 individual wiring line, 27 end portion, 28 terminal portion, 29 lead-out wiring line, 30 resistor layer, 31 heat generation portion, 33 protective layer, 35 drive circuit, 36, 37 conductive wire, 40 connector, 43 sealing member, 45 protrusion, 46 platen roller, 47 print medium, 49 heat sink, h thickness, V region.

1. A thermal print head comprising:
a substrate having a main surface; and
a glaze layer disposed on the main surface, wherein
the glaze layer includes a hollow filler.

2. The thermal print head according to claim 1, wherein the hollow filler contains glass.

3. The thermal print head according to claim 1, wherein a material forming the substrate is silicon.

4. The thermal print head according to claim 3, wherein
the main surface is provided with a protruding portion, and
the glaze layer covers a top surface of the protruding portion.

5. The thermal print head according to claim 4, wherein
the glaze layer has a curved surface portion, and
when a direction perpendicular to the main surface is defined as a z direction,
the curved surface portion overlaps with the protruding portion in a plan view seen in the z direction.

6. The thermal print head according to claim 5, wherein a thickness of the glaze layer in the z direction is 20 μm or more and 250 μm or less.

7. The thermal print head according to claim 1, further comprising:
an insulating layer; and
a resistor layer, wherein
the insulating layer is disposed on the main surface,
the resistor layer is disposed on the insulating layer, and
the glaze layer is located between the main surface and the resistor layer.

8. The thermal print head according to claim 7, wherein the glaze layer is disposed between the resistor layer and the insulating layer.

9. The thermal print head according to claim 7, wherein the glaze layer is disposed between the insulating layer and the main surface.
